(19) United States
(12) Patent Application Publication
(10) Pub. No.: US 2008/0317935 A1
(43) Pub. Date: Dec. 25, 2008

(54) SHREDDED MEAT PROCESSING METHOD

(76) Inventors: John Stanley, Harrisburg, IL (US); John David Stanley, Harrisburg, IL (US)

Correspondence Address: PATRICK W. RASCHE;ARMSTRONG TEASDALE LLP, ONE METROPOLITAN SQUARE, SUITE 2600, ST. LOUIS, MO, 63102-2740, US

(21) Appl. No.: 11/765,594

(22) Filed: Jun. 20, 2007

(51) Int. Cl. A23L 1/31; A23L 1/22

(52) U.S. Cl. 426/638

(57) ABSTRACT

The present invention generally relates to a method for processing a wide variety of raw meats to yield a cooked, spiced meat product. More particularly, the present invention related to an efficient, large-scale method for preparing a spiced meat product having an improved texture and/or taste, at least in part due to the moisture content thereof, which utilizes steam-based cooking to advantageously reduce cooking time and/or energy consumption. The present invention is further directed to the cooked, spiced meat product resulting from such a method. The present invention is further directed to the cooked, spiced meat product resulting from such a method, and in particular such a product that has a shredded appearance or texture.

### FIELD OF THE INVENTION

The present invention generally relates to a method for processing a wide variety of raw meats to yield a cooked, spiced meat product. More particularly, the present invention related to an efficient, large-scale method for preparing a spiced meat product having an improved texture and/or taste, at least in part due to the moisture content thereof, which utilizes steam-based cooking to advantageously reduce cooking time and/or energy consumption. The present invention is further directed to the cooked, spiced meat product resulting from such a method, and in particular such a product that has a shredded appearance or texture.

### BACKGROUND OF THE INVENTION

A number of commercial methods are generally known for preparing a cooked, spiced meat product (e.g., Italian-style sliced beef, shredded or sliced barbecued beef, French-dip style sliced beef, etc.) that is suitable for human consumption. Typically, such methods employ dry heat cook (e.g., roasting, broiling, smoking, grilling, barbecuing, etc.). For commercial production, these methods utilize large slabs or cuts of meat, which require extended cooking times (e.g., 10 hours or more). The combination of dry heat cooking and the long cooking times act to reduce the moisture content of the meat to an undesirably low level. Additionally, such methods often wait until after the resulting cooked meat has been sliced, shredded, ground, etc., before it is contacted with various spice blends and packaged. As a result, such methods often yield a product that may be tough and/or dry, and that may have a low degree or level of taste or flavor.

### SUMMARY OF THE INVENTION

Briefly, the present invention is directed to a method for preparing a cooked, spiced meat product. The method comprises: (i) extruding a raw cut of meat through a plate, wherein the plate has a plurality of openings therein having a diameter or width of at least about 0.5 inches; (ii) cooking a combination of the extruded raw meat, spices and water at a temperature of at least about 170° F. (about 77° C.) for at least about 0.5 hours to less than about 5 hours to obtain a cooked meat product; (iii) collecting the cooked meat product and resulting liquid, wherein the collected cooked meat product and liquid have a combined weight that is at least about 15 percent greater than the weight of the extruded raw meat, prior to cooking; and, (iv) cooling the collected meat product and liquid together to a temperature of less than about 40° F. (about 4° C.).

The present invention is further directed to such a method wherein the cooked meat product has a shredded appearance or texture.

The present invention is still further directed to a method for preparing a cooked, spiced meat product having a shredded texture or appearance. The method comprises: (i) extruding a raw cut of meat through a plate have a plurality of openings therein to obtain a shredded raw meat product; (ii) agitating a combination of the shredded raw meat, spices and water to obtain a uniform mixture; (iii) heating the agitated mixture to a uniform temperature of at least about 180° F. (about 82° C.) (i.e., the temperature throughout substantially the entire mixture is at least about 170° F. (about 77° C.)), for a time sufficient to obtain a cooked meat product having a shredded appearance; (iv) collecting the cooked meat product and resulting liquid, wherein the collected cooked meat product and liquid have a combined weight that is at least about 30 percent greater than the weight of the shredded raw meat prior to cooking; and, (iv) cooling the collected cooked meat product and liquid together to a temperature of less than about 40° F. (about 4° C.).

The present invention is still further directed to one or more of the above-noted methods wherein the combination of extruded meat, spices, and water are cooked inside a vessel with the temperature therein being sufficient to vaporize water present therein to form steam, such that the extruded meat is at least partially cooked by the steam formed inside the vessel.

The present invention is still further directed to one or more of the above-noted methods wherein the cooked meat product is collected in packages, and then cooled inside the packages.

The present invention is still further directed to one or more of the above-noted methods wherein the method is suitable for use on a commercial scale; that is, the method is capable of preparing, on a daily average, thousands of pounds of product per hour (e.g., at least about 2,500 pounds, about 5000 pounds, about 10,000 pounds, about 15,000 pounds, about 20,000 pounds or more per hour).

The present invention is still further directed to one or more of the above-noted methods wherein the product obtained therefrom is suitable for human consumption.

The present invention is still further directed to the cooked meat product of one or more of the above-noted methods.

Other objects and features will be in part apparent and in part pointed out hereinafter.

### DESCRIPTION OF THE PREFERRED EMBODIMENTS

The present invention generally relates to a method for processing a wide variety of raw meats to yield a cooked, spiced meat product. More particularly, and in accordance with the present invention, an efficient, steam-based cooking method has been discovered which yields a spiced meat product having an improved texture and/or taste. Without being held to any particular theory, it is generally believed that the combination of grinding or extruding the large slabs or pieces of raw meat prior to cooking, followed by cooking the ground or extruded meat in the presence of a mixture of water and spices, yields a product that has an improved texture (e.g., more moist) and has an improved (e.g., stronger) flavor, as compared for example to a method wherein the large slabs or pieces are meat are first cooked using dry heat, sliced, and then only contacted with a liquid spice mixture at the time of, or just prior to, packaging.

In this regard it is to be noted that the method of the present invention is preferably designed for the manufacture of a product suitable for human consumption, which generally means that the product meets or exceeds all applicable F.D.A. requirements or regulations.

It is to be further noted that the method of the present invention is well-suited for being carried out in a batch or continuous system. Additionally, the method is preferably designed for commercial-scale, or large-scale, batch or continuous production of such a product; that is, the method is capable of preparing, on a daily average (i.e., the average weight of product produced over at least about 1, about 2, about 3 or more periods of about 24 hour each), thousands of pounds of product per hour (e.g., at least about 2,500 pounds, about 5000 pounds, about 10,000 pounds, about 15,000 pounds, about 20,000 pounds or more per hour).

It is to be still further noted that, as used herein, “steam-based” cooking generally refers to a method of cooking involving steam, which may include, for example, the use of a steam-jacketed cooker and/or the use of steam-injected cooking (i.e., steam injected into the cooking compartment and/or the ground or extruded raw meat itself, during cooking). Additionally, or alternatively, “steam-based” cooking may simply refer to the a method wherein raw meat is cooked in the presence of water, at a sufficient temperature, such that water vapor (or steam) is formed inside the cooking compartment (e.g., kettle) of a cooker or cooking apparatus, which in turn is responsible for at least partially cooking the meat present therein.

It is to be still further noted that, in one or more preferred embodiments detailed herein, the cooked, spiced meat has a “shredded” appearance; that is, the cooked, spiced meat is in the form of shreds (e.g., small pieces of meat that are long, narrow strips, similar to, for example, the appearance of a pulled pork or beef). Accordingly, in such an embodiment the product has a notably different appears than, for example, a ground product (e.g., ground beef, or hamburger, product). It is to be still further noted that the method of the present invention yields such a spiced meat product that is packaged for later consumption in the presence of a flavor-rich liquid (e.g., a broth), and as such has a moisture content that is higher than the moisture content of the meat prior to cooking (as further detailed elsewhere herein).

As further detailed herein below, it is to be noted that the method of the present invention generally involves the following steps: (1) loading large slabs or pieces of raw meat into an extruder or grinder, or onto a conveyor for transport thereto; (2) converting the large pieces of meat into small, coarse particles by extruding, or grinding, the large pieces of meat through a die, or grinding plate, which acts to tenderize the meat, while preferably avoiding the formation of a finely ground material; (3) cooking, with agitation or mixing, a combination of the ground or extruded meat, spices, and water, the cooking time and temperature selected to ensure thorough cooking of the meat (e.g., cooking the meat until it is substantially “well-done”, as understood and determined by one of ordinary skill in the art); (4) collecting the spiced cooked meat and the liquid resulting therefrom, (e.g., the broth or “pot liquor” from the cooking device), and then preferably placing the collected combination of cooked meat and liquid in vacuum sealed bags or plastic containers; and (5) cooling the collected combination of the cooked spiced meat product and liquid.

In this regard it is to be noted that various modification or optional steps may be introduced without departing from the intended scope of the present invention. For example, the collected product (i.e., the spiced cooked meat and liquid or broth) may be cooled and then packaged, or it may be collected and packaged while still hot from the cooking step. Additionally, or alternatively, the collected (e.g., packaged) product may be slowly cooled for an extended duration (as further detailed herein below), in order to allow the flavor of the spices to more fully permeate or saturate the meat, or it may be frozen soon after vacuum packaging (by, for example, a flash-freezing process), to for example further reduce the overall duration of the meat preparation method.

### 1. Raw Materials

The method of the present invention may be used to prepare a spiced meat product from a broad variety of raw meat types and/or cuts. For example, suitable meat types may include any beef, venison, elk, buffalo, or other large domestic livestock and wild game species. Additional sources of meat may include, for example, sheep, caribou, moose, antelope, hog, and boar, among others. Regarding the cuts of meat that may be used, for meat types such as those noted here (e.g., beef, venison, elk, buffalo, and the like), it is to be noted that essentially any cut of meat is potentially applicable to the method of the present invention, including for example standard cuts such as a roast, an arm roast, a top round, a bottom round, and a loin or sirloin, among others.

The method of the present invention may also be used to prepare a spiced meat product from any fowl or poultry meat including chicken, duck, goose, pheasant, turkey, and ostrich, among others. Regarding the cuts of meat that may be used from these sources, again it is to be noted that essentially any cut is potentially applicable to the method of the present invention, including for example standard cuts from the leg, thigh, and breast, among others.

### 2. Grinding/Extruding

As previously noted, the present invention is particularly well-suited for large-scale, or commercial, processing of meat. As a result, large quantities of meat may be processed at one time. For example, in one embodiment, a large quantity (e.g., at least about 500 pounds, about 1000 pounds, about 2000 pounds, about 4000 pounds, about 5000 pounds or more) of raw, de-boned meat are fed at one time or continuously into the hopper of an extruder or grinder. This may be done manually, or alternatively by means of a partially or fully automated process (e.g., by manual loading the meat onto a conveyor, which transports the meat to an extruder or grinder).

The raw meat is preferably cool, such as less than about 45° F., about 40° F., or even about 35° F. (e.g., less than about 7° C., about 4° C., or about 2° C., respectively). For example, the raw meat may be cooled by refrigeration or by exposure to, for example, ice in order to reduce the temperature, to for example, between about 35 to about 40° F. (about 2 to about 4° C.). In this regard it is to be noted, however, that it is desirable to avoid grinding frozen or partially frozen meat cuts, since this may increase the wear on the grinding equipment and plate or dye. Accordingly, the meat source preferably has a temperature ranging from about 35 to about 40° F. (about 2 to about 4° C.) at essentially all times during grinding or extruding.

The grinder or extruder may be essentially any grinder or extruder commercially available for processing meat in this way. For example, one such grinder or extruder is the AFMG Series Mixer/Grinder, manufactured by Daniels Food Equipment from Parkers Prairie, Minn. This series includes the AFMG 400, AFMG 600, and AFMG 800 size grinders, and the choice of grinder may be made based on the capacity desired. Generally speaking, the grinder is equipped with one or more screws or augers which force the raw material (meat) through a grinding plate or extrusion dye, and which may optionally act to mix and/or partially break down the size of the raw material prior to contacting the grinding plate or extrusion die.

The grinding plate or extrusion die typically has a plurality of openings, which may for example be substantially circular, oval, square, rectangular, etc. in shape, with circular being preferred in one particular embodiment. The size and/or shape and/or number of the holes in the grinding plate or extrusion die may be optimized based on such a number of factors, such as for example the texture or firmness of the raw material, and/or the desired texture or appearance of the resulting ground or extruded product, and/or the output of the apparatus. However, without being held to any particular theory, it is generally believed that larger openings are preferred in the method of the present invention, since grinding or extrusion is desirably designed to yield a tenderized meat product that maintains the integrity of the meat cut (e.g., the resulting meat product still possesses some connective tissue that maintains the meat in distinct pieces, rather than small individual granules); that is, the resulting product in at least one preferred embodiment desirably has a shredded appearance and texture, rather than for example the appearance or texture of small, individual or loosely associated particles (such as, for example, in the case of ground beef).

In view of the foregoing, it is to be noted that the openings of the grinding plate or extrusion die typically have a diameter, or alternatively a width or cross-section, of at least about 0.5 inches (about 1.25 cm) or larger. This is at least in part because experience to-date suggests that if the openings get too small, the result product may be less suitable for further processing in accordance with the present method. Additionally, the maximum size (e.g., diameter, or alternatively width or cross-section) of the openings in the grinding plate or extrusion die may be determined in view of other processing considerations (e.g., the cooking duration, given that larger openings yield larger pieces of meat that may require longer cooking times to achieve the desired consistency of the final spiced meat product). In view thereof, although larger openings may be used, it is preferable to use grinding plates having a maximum opening size of about 1 inch (about 2.5 cm) or smaller. Typically, therefore, the grinding plate has openings having diameters (or width/cross-section) of from about 0.5 inch to about 1 inch in one preferred embodiment, or between about 0.6 and about 0.85 inches (about 1.5 cm to about 2 cm).

With respect to the number of openings or holes in the grinding plate or extrusion die, it is to be noted that this is in part a function of the desired output or throughput of the grinder or extruder, the desired size of the material being extruded or ground, as well as the overall size or diameter of the plate or die itself. For example, in view of these considerations, in various embodiments the number of holes or openings in the plate may be such that the total potential surface area of the plate is reduced by at least about 25%, 50%, 75% or more, due to the number of holes or openings therein (wherein the “total potential surface area” of the plate refers to the surface thereof without any holes therein, the reduction in surface area therefore resulting from the holes being present therein). For example, for a plate having a diameter of about 6 inches (about 15 cm), typically the number of holes or openings (e.g., holes having a diameter of between about 0.5 and about 1 inch) present therein is greater than about 1 to about 55 (e.g., about 5, about 10, about 20, about 30, about 40, or about 50 holes or openings). In one particular embodiment, the plate has a diameter of about 6 inches and about 54 holes or openings of a diameter of about 0.5 inch. In another particular embodiment, the plate has a diameter of about 6 inches and about 12 holes or openings of a diameter of about 1 inch.

The conditions used for grinding or extruding the raw meat, including for example the feed rate, auger or feed screw rotation speed, and other factors (such as for example grinding temperature, should some temperature control be need in order to prevent the raw material from becoming too hot, which may slow the grinding or extrusion process), may be chosen according to, for example, the desired tenderness, consistency, or moisture content, of the final ground or extruded material (or alternatively the cooked, spiced meat product). In one embodiment, the feed rate (or auger speed) may be chosen to yield at least about 100 pounds, about 200 pounds, about 400 pounds of ground meat product per minutes or more, such as for example between about 200 pounds and about 400 pounds of ground meat product per minute. Additionally, or alternatively, the screw or auger rotation speed may be at least about 40 rotations/minute (rpm), at least about 50 rpm, at least about 60 rpm, at least about 75 rpm or more, the rotation speed for example being between about 40 and about 60 rpm, or between about 50 and about 75 rpm.

As previously noted, the grinding or extrusion step preferably yields a tenderized meat product having some integrity (i.e., consists of coarse particles rather than having a minced or hamburger-like texture). Additionally, the temperature of the resulting ground meat product is preferably substantially the same as the temperature of the meat prior to grinding or extrusion (e.g., a temperature changes of less than about 10, about 8, about 6, about 4, or even about 2 degrees). Finally, the resulting ground meat product preferably has a water content which is substantially the same as the water content prior to grinding or extrusion; that is, the water content of the meat prior to grinding is typically between about 55 and about 75 weight percent, or between about 60 and about 70 weight percent (as compared to the total weight of the raw meat), and the water content of the ground meat product is substantially unchanged (e.g., the water content of the ground meat product changes by less than about 10, about 8, about 6, about 4, or even about 2 weight percent, as compared to the water content of the meat prior to grinding or extrusion). Accordingly, it is to be noted that the grinding or extrusion step preferably substantially avoids cooking or removing water from the meat.

### 3. Cooking

Once the grinding or extruding step has been completed, the resulting raw (or uncooked) meat product is then combined or contacted with a mixture of spices and water, and then heated and agitated/mixed in order to cook the meat, and preferably subject the meat to steam-based cooking. Generally speaking, this combination may be cooked using essentially any device known to one of ordinary skill in the art. In one particular embodiment, the ground or extruded meat product is placed into a steam-jacketed kettle or vessel to be steam cooked in the presence of the added water and spices. In one preferred embodiment, the steam-jacketed kettle or vessel uses paddles to rotate the mixture and break the meat down, preferably in order to give the resulting cooked, spiced meat a shredded appearance.

The steam jacketed kettle or vessel may be essentially any kettle or vessel know for used to steam cook meat, such as, for example, a Horizontal Kettle with Agitator, (Model THPT-HS-x) manufactured by TUCS Equipment, Inc., from Fridley, Minn. Kettles available from this manufacturer come in a variety of sizes/capacities and internal diameters. For example, the capacity of the kettle or vessel may vary from about 70 to about 430 gallons (about 500 pounds (about 225 kg) to about 3200 pounds (about 1450 kg)), with the internal diameter varying from about 24 to about 42 inches (about 0.6 m to about 1.1 m), depending upon the particular model. The kettle is equipped with a horizontal “paddle wheel” that may be used to agitate the meat during steam cooking and continuously scrape the meat from the side of the kettle in order to prevent burning or sticking of the meat. The rotation speed of the paddle wheel may be optimized in view of, for example, the quantity of meat, spices, and water present in the kettle or vessel, and/or the desired texture of the finished product. Typically, however, the rotation speed of the paddles (in, for example, the Horizontal Kettle with Agitator, Model THPT-HS-x, noted above) is greater than about 1 rotation/minute (rpm) to less than about 20 rpm, or from about 5 to about 15 rpm, with about 10 rpm being preferred in one particular embodiment.

The processing conditions (e.g., the duration and temperature of the cooking step) may be optimized in order to limit the cooking time to the shortest duration possible and yet still obtain a product of desired taste, texture, moisture content, etc. Typically, however, the temperature, or the combination of temperature and pressure (if the cooking device is designed to allow for elevated pressure, such as commercially available pressure cookers), are such that the duration of the cooking step is at least about 0.5 hours, about 1 hour or about 2 hours, and less than about 5 hours, about 4 hours, or even about 3 hours, the cooking time for example ranging from about 0.5 hours to less than about 5 hours, or from about 1 hour to about 4 hours.

In one preferred embodiment, cooking involves first heating the contents of the kettle or vessel, preferably with agitation (such as by means of paddle rotation), to a temperature sufficient to bring the water to a simmer, such as to a temperature of at least about 150° F. (about 65° C.), about 170° F. (about 77° C.), about 185° F. (about 85° C.), about 195° F. (about 90° C.), about 200° F. (about 93° C.) or more, the temperature for example ranging from about 170° F. (about 77° C.) to about 200° F. (about 93° C.). Typically, the kettle is heated with agitation over a period of about 0.5 to about 1 hour, in order to reach the desired temperature, and then the temperature is maintained, in order to allow the contents of the kettle to simmer, with agitation for about another 1 to 2 hours to release the flavor of the spices. Once the desired shredded consistency is achieved, paddle rotation may be stopped, and cooking may continue until the desired product is obtained (e.g., the meat is cooked to the desired degree or level of doneness).

In this regard it is to be noted that, in one preferred embodiment, the duration and/or temperature of the cooking step is optimized in order to achieve the desired degree or level of meat doneness, which is often measured or determined by the average internal temperature at the center of the meat being cooked. Accordingly, in various embodiments the meat is typically cooked until the average internal temperature is at least about 170° F. (about 77° C.) or at least about 175° F. (about 80° C.) for various types of meat including beef, venison, elk, buffalo, sheep, caribou, moose, antelope, hog, and boar. With respect to poultry types including chicken, duck, goose, pheasant, turkey, and ostrich, meat doneness is indicated by average internal temperatures of at least about 180° F. (about 82° C.).

In this regard it is to be further noted that, in one preferred embodiment, the meat is cooked under conditions sufficient to ensure that it is essentially well-done, wherein “well-done” is as understood and determined by one of ordinary skill in the art.

In this regard it is to be still further noted that, in one particular embodiment, the kettle or vessel is designed to be sealed (and thus maintain the pressure present therein) in order to substantially contain water vapor (or steam) formed during the cooking step. Optionally, the temperature (or more generally the cooking conditions, such as time, temperature or pressure) is selected in order to promote the formation of steam therein, such that the meat present therein is at least partially cooked by the steam therein. Accordingly, in one particular embodiment, the cooker is designed to inject steam directly into the combination of meat, water and spices, in order to at least partially steam cook the meat therein. In such an embodiment, preferably the cooker is designed to substantially maintain atmospheric pressure inside the kettle thereof; that is, the cooker is designed to enable steam injection sufficient to cook the meat product of the present invention without essentially any added or increased pressure therein. The cooking method of the present invention may, however, employ pressures above atmospheric pressure, such as by, for example, pressure cooking. In this regard, steam injection may increase the internal kettle pressure, for example, to about 10 psi (pounds per square inch) (about 69 kPa), about 20 psi (about 138 kPa), or about 30 psi (about 207 kPa).

In this regard it is to be still further noted that an additive, such as MSG (monosodium glutamate) may optionally be added to assist in meat tenderization.

Generally speaking, the spices to be added to the ground or extruded meat may generally be chosen according to conventions known to one of ordinary skill in the art of meat preparation. For example, a spiced beef product may be cooked with a spice mixture including Italian seasoning, basil, oregano, garlic, and other spices. Other meat types, such as buffalo, chicken, venison, etc. may be cooked with a spice mixture tailored to the particular source of meat, or the desired taste of the final cooked, spiced meat product.

Like the types of spices that may be combined with the ground or extruded meat, the amount of spices combined therewith may also be generally determined according to conventions known to one of ordinary skill in the art of meat preparation. Furthermore, as previously noted, the present invention is particularly well-suited for large-scale, or commercial, processing of meat. As a result, large quantities of meat may be processed at one time, which in turns means comparably large quantities of spices may also be used or combined therewith. For example, in one particular embodiment, the amount of spices (in solid or granular form) used may range from at least about 200 pounds to less than about 450 pounds, or from about 250 pounds to less than about 400 pounds, or from about 300 pounds to about 350 pounds. More particularly, however, it is to be noted that ratio of the weight of ground or extruded meat to the weight of spices is typically between about 15:1 and about 2.5:1, or between about 12.5:1 and about 5:1, or between about 10:1 and about 7.5:1.

Like the amount of spices that may be combined with the ground or extruded meat, the amount of water combined therewith may also be generally determined according to conventions known to one of ordinary skill in the art of meat preparation. Furthermore, as previously noted, the present invention is particularly well-suited for large-scale, or commercial, processing of meat. As a result, large quantities of meat may be processed at one time, which in turns means comparably large quantities of water may also be used or combined therewith. For example, in one particular embodiment, the amount of water used may range from at least about 750 pounds to less than about 2000 pounds, or from about 1000 pounds to less than about 1750, or from about 1250 pounds to about 1500 pounds. More particularly, however, it is to be noted that ratio of the weight of ground or extruded meat to the weight of water is typically between about 5:1 and about 1:1, or between about 4:1 and about 1.5:1, or between about 3:1 and about 2:1. Additionally, or alternatively, it is to be noted that ratio of the weight of water to the weight of spices is typically between less than about 7.5:1 and greater than about 1:1, or between about 6:1 and about 2:1, or between about 5:1 and about 3:1.

In this regard it is to be noted that one of ordinary skill in the art would recognize that if the combination of meat, water, and spices is to be heated fully or partially by direct steam injection into the combination, the amount of water initially added thereto may be adjusted (e.g., reduced) as needed to account for the water added by condensation of the steam therein.

In this regard it is to be further noted that the spices may be combined with the ground or extruded meat in solid or granular form. Alternatively, however, the spices may be first dissolved or suspended in water (or, more generally, an aqueous solution), and then the liquid spices mixture or solution may be combined with the ground or extruded meat. In yet another alternatively, however, the ground or extruded meat may be combined with the water, and then the solid or granular spices may be added thereto or combined therewith. Accordingly, it is to be further noted that the scope of the present invention is intended to cover all such options with respect to orders of addition.

It is to be still further noted that one or more of the additions or combinations noted herein may be done manually, or alternatively by means of a partially or fully automated process.

Once the cooking step has been completed (e.g., once substantially all of the meat present in the cooker is “well-done”), the resulting product (i.e., the contents of the kettle of the cooker, which is the cooked meat and the liquid, or broth, present therein) is collected. Due to the water added as part of the cooking step, the resulting product has a substantially higher water content than the raw, extruded meat prior to cooking. Additionally, due to the added water and spices, the resulting product has a substantially higher weight than the raw, extruded meat product prior to cooking. More specifically, the collected product (i.e., the spiced, cooked meat and the liquid resulting therefrom, which may also referred to as a “broth” or more generally the “pot liquid” from the cooking step) may have a total weight (i.e., the sum of the weight of the spiced, cooked meat and the weight of the resulting liquid that is collected from the cooker) that is about 115%, about 120%, about 130%, about 140%, about 150%, about 170% or more of the weight of the raw, extruded meat prior to cooking; stated another way, the cooking process may increase the weight of the final product, as compared to the weight of the raw, extruded meat prior to the cooking step, by at least about 15%, about 20%, about 30%, about 40%, about 50%, about 70%, or more. Accordingly, it is to be noted that the final product of the present invention comprises the cooked, spiced meat having a shredded appearance and a flavor-rich liquid or broth.

### 4. Cooling and Packaging

After steam cooking, the still hot spiced meat product, which comprises the cooked, spiced meat preferably having a shredded appearance and the flavor-rich broth or sauce, is collected, and then packaged and cooled (or alternatively cooled and then packaged). In one preferred embodiment, upon completion of the cooking step, the cooked meat product is collected and then, while still hot (e.g., a temperature in excess of about 150° F. (about 65° C.), 170° F. (about 77° C.), about 200° F. (about 93° C.) or more), may be placed in a plastic container or plastic bag. The spiced meat product is preferably packaged hot for several reasons, including for example because: (i) the spiced meat product, when sufficiently hot, may pasteurize the bag or container in which it is placed, and/or (ii) packaging the meat product while still hot gives the spices additional time to fully permeate and flavor the meat, and/or (iii) immediately packaging the product and then allowing the product to cool in the packages may increase the overall throughput or output of the present method. Accordingly, it may be preferred, in one particular embodiment, for the method to be designed to limit the time, and/or temperature drop that occurs between the cooked meat product exiting the cooker and entering the package. For example, it may be preferred for the cooked meat product to be packaged (i) within less than about 30 minutes, about 20 minutes, about 10 minutes, about 5 minutes, or even about 1 minute from the time it exits the cooker, and/or (ii) before the temperature thereof decreases by more than about 20 degrees, about 15 degrees, about 10 degrees, or even about 5 degrees.

In this regard it is to be noted, however, that the cooked product may be collected and then allowed to cool fully or partially before packaging, without departing from the scope of the present invention.

Generally speaking, essentially any conventional filling and sealing machine may be used to package the hot, cooked meat product, such as for example the Vertical Form/Fill/Seal Machine Model FFS-1, manufactured by TUCS Equipment, Inc., from Fridley, Minn. In one preferred embodiment, the filled container or bag is vacuumed sealed. In one embodiment, between about 10 pounds and about 50 pounds of meat, or between about 20 pounds and about 40 pounds of meat, is packaged in one bag or container. In this regard it is to be noted, however, that the bag or container size or shape may vary, for example as a function of the intended customer (e.g., wholesale or retail), and therefore should not be interpreted to limit the scope of the present invention in any way.

After the cooking step has been completed, and before and/or after packaging, the cooked meat product is cooled. Cooling may occur in essentially any manner, and using essentially any equipment, known to one of ordinary skill in the art to be suitable for cooling such a product according to all applicable regulations for the desired end use of the product (e.g., according to F.D.A. requirements, such as, for example F.D.A. Regulations 3-501.15 and 3-501.16, the cooked product is to be cooled to a temperature of less than about 40° F. (about 4° C.)). For example, one suitable means for cooling the cooked product is a chiller, such as the Continuous Linear Rapid Chiller System Model TCS-x FT-x LN, manufactured by TUCS Equipment, Inc., from Fridley, Minn.

Regarding the equipment used, it is to be noted that, in one embodiment, cooked (and optionally packaged) product may be cooled to about 40° F. (about 4° C.) or less over a period of less than about 2 hours, 1.5 hours, 1 hour, or less; that is, the product may be cooled, upon exiting the cooker, at an average rate of at least about 1 degree/minute, about 2.5 degrees/minute, or about 5 degrees/minute. The chiller may then maintains the packaged spiced meat product at about 40° F. (about 4° C.) or less for at least about 5 hours, about 10 hours or more, and in one preferred embodiment between about 10 and about 12 hours, in order to allow for spices to release their flavors and fully permeate or saturate the meat product. The product may then be placed into a freezer to freeze the product and prepare it for shipping.

In this regard it is to be noted, however, that in another preferred embodiment the cooked meat product may be frozen soon after it exits the cooker, and more preferably frozen immediately after having been packaged (which preferably occurred soon after the cooked meat exited the cooker). For example, in one particular embodiment, the cooked meat is packaged soon after exiting the cooker (as detailed herein above) and then the packaged product is frozen (i.e., cooled to a temperature below about 32° F. (about 0° C.)) as soon as possible thereafter placing the packaged product in a freezer (e.g., in less than about 30 minutes, about 20 minutes, about 10 minutes, about 5 minutes, or even less), the packaged product for example being cooled at a rate of at least about 10 degrees/minute, about 20 degrees/minute, about 30 degrees/minute or more. In this embodiment, the preparation time is greatly reduced, in comparison for example to processes in which the meat is slowly cooled, thus increasing throughput while not compromising the quality of the cooked meat product.

### 5. Batch and Continuous Methods

It is to be noted that the present invention may be carried out in a batch, or alternatively in a continuous, manner. In one preferred embodiment, a continuous method is employed, which may for example be configured to yield as about 3.5 million pounds of cooked meat product per week.

Having described the invention in detail, it will be apparent that modifications and variations are possible without departing from the scope of the invention defined in the appended claims.

### EXAMPLE

The following non-limiting Example is provided to further illustrate the present invention.

### Preparation of a Shredded Beef Roast Product

A batch of the spiced meat product of the present invention was prepared in accordance with the method detailed herein above according to the following protocol:

Approximately 3500 pounds (about 1588 kg) of a grade select beef roast was fed into a meat grinder (AFMG 800 Mixer/Grinder, manufactured by Daniels Food Equipment from Parkers Prairie, Minn.). The grinder and the beef roast were cooled to be between about 36° F. and about 40° F. (about 2° C. to 4° C.) when the grinder was turned on. The meat was ground through a plate having 54 circular holes therein, each hole having a diameter of about 0.5 inches (about 1.27 cm).

Upon exiting the grinder, the ground meat product had a temperature between about 36° F. and about 40° F. (about 2° C. to 4° C.) and a moisture content of about 70% by weight. All of the ground meat was collected, and then it was placed into a steam fed, hot water jacketed kettle (Model THPT-HS-x Horizontal Kettle with Agitator, manufactured by TUCS Equipment, Inc., from Fridley, Minn.). About 336 pounds (about 148 kg) of a spice mixture and about 1500 pounds (about 680 kg) were added to the kettle. The kettle was sealed and heated to a temperature of about 200° F. (about 93° C.) by means of passing steam through the jacket and additionally injecting steam into the kettle and meat therein. The ground meat inside the kettle was agitated or mixed (using the steam kettle's horizontal “paddle wheel”) at a speed of about 10 rotations per minute for about 3 hours. The resulting product comprised cooked, spiced meat having a shredded appearance and a broth. The meat and broth was then jointly removed from the kettle and collected. It was observed that the cooking step increased yielded a product (i.e., the combination of the cooked meat and broth) having a weight that was approximately 130% of the pre-cooked weight of the meat (i.e., the weight of the raw, ground meat prior to cooking).

The spiced, cooked meat product and broth, the temperature of which was about 175° F. (about 80° C.), was then immediately vacuum packaged, by transferring the meat and broth to a vacuum packaging device (model FFS-1 Vertical Form/Fill/Seal Machine, manufactured by TUCS Equipment, Inc., from Fridley, Minn.)). Batches of about 2.5 pounds of the spiced, cooked meat and broth product were placed in individual nylon bags (KENYLENE™ Cook Chill Bags, manufactured by KNF Corporation, Tamaqua, Pa.), and vacuum sealed. The vacuum packaged bags were then placed in a chiller (Model TCS-x FT-x LN Continuous Linear Rapid Chiller System, manufactured by TUCS Equipment, Inc., from Fridley, Minn.) to bring the temperature down to 40° F. (about 4 to 5° C.) over a period of about one hour. The product is then placed in a cooler at about 40° F. (about 4 to 5° C.) for between 10 to 12 hrs to allow for spices to unleash their flavor. The bags are then placed into a freezer to prepare for shipping.

In view of the above, it will be seen that the several objects of the invention are achieved and other advantageous results attained.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above methods without departing from the scope of the invention, it is intended that all matter contained in the above description shall be interpreted as illustrative and not in a limiting sense.

What is claimed is:

1. A method for preparing a cooked, spiced meat product suitable for human consumption, the method comprising:
extruding a raw cut of meat through a plate, wherein the plate has a plurality of opening therein having a diameter or width of at least about 0.5 inches;
cooking a combination of the extruded raw meat, spices, and water at a temperature of at least about 170° F. for at least about 0.5 hours to less than about 5 hours to obtain a cooked meat product;
collecting the cooked meat product and resulting liquid, wherein the collected cooked meat product and liquid have a combined weight that is at least about 15 percent greater than the weight of the extruded raw meat, prior to cooking; and,
cooling the collected meat product and liquid to a temperature of less than about 40° F.

2. The method of claim 1 wherein a source of the raw cut of meat is selected from among beef, venison, elk, buffalo, sheep, caribou, moose, antelope, hog, and boar.

3. The method of claim 1 wherein a source of the raw cut of meat is selected from among chicken, duck, goose, pheasant, turkey, and ostrich.

4. The method of claim 1 wherein the grinding plate comprises between greater than 1 and about 50 openings.

5. The method of claim 1 wherein the grinding plate has a plurality of openings, each having a diameter or width of between about 0.5 inch and about 1 inch.

6. The method of claim 1 wherein the grinding plate comprises between greater than 1 and about 50 openings, wherein each of said openings has a diameter or width between about 0.5 inch and about 1 inch.

7. The method of claim 1 wherein the raw cut of meat is extruded through the plate at a feed rate of at least about 100 pounds per minute.

8. The method of claim 1 wherein the raw cut of meat is extruded through the plate at a feed rate of between about 200 pounds per minute and about 400 pounds per minute.

9. The method of claim 1 wherein the combination of raw ground meat, water, and spices are steam cooked.

10. The method of claim 1 wherein the combination of raw ground meat, water and spices are cooked with agitation to obtain a cooked, spiced meat having a shredded appearance.

11. The method of claim 1 wherein the combination of raw ground meat, water and spices are cooked for between about 1 and about 4 hours.

12. The method of claim 1 wherein the combination of raw ground meat, water, and spices are cooked at a temperature of at least about 200° F.

13. The method of claim 1 wherein a weight of the extruded, raw meat and a weight of spices combined is such that a ratio of the weight of the extruded, raw meat to the weight of spices is between about 15:1 and about 2.5:1.

14. The method of claim 1 wherein a weight of the extruded, raw meat and a weight of water combined is such that a ratio of the weight of the extruded, raw meat to the weight of water is between about 5:1 and about 1:1.

15. The method of claim 1 wherein the collected cooked meat product and liquid have a combined weight that is at least about 30 percent greater than the weight of the extruded raw meat prior to cooking.

16. The method of claim 1 wherein the cooked meat product is collected and packaged in a plastic container or a plastic bag, and further wherein the temperature of the cooked meat is sufficiently high to effectively pasteurize the plastic container or the plastic bag.

17. The method of claim 16 wherein the cooked meat product is vacuum-sealed in the plastic container or the plastic bag.

18. The method of claim 1 wherein the collected meat product is cooled to a temperature of less than about 40° F. within less than about 1 hour.

19. The method of claim 18 wherein the collected meat product is maintained at a temperature of less than about 40° F. for at least about 5 hours.

20. The method of claim 19 wherein the collected meat product is maintained at a temperature of less than about 40° F. for between about 10 hours and about 12 hours.

21. The method of claim 1 wherein the collected meat product is cooled to a temperature of less than about 30° F., in order to freeze the product, within less than about 10 minutes.

22. A method for preparing a cooked, spiced meat product having a shredded texture or appearance, the method comprises:
extruding a raw cut of meat through a plate have a plurality of openings therein to obtain a shredded raw meat product;
agitating a combination of the extruded, shredded raw meat, spices, and water to obtain a uniform mixture;
heating the agitated mixture to a uniform temperature of at least about 170° F. for a time sufficient to obtain a cooked meat product having a shredded appearance;
collecting the cooked, shredded meat product and resulting liquid, wherein the collected cooked meat product and liquid have a combined weight that is at least about 30 percent greater than the weight of the shredded raw meat prior to cooking; and,
cooling the collected cooked, shredded meat product and liquid together to a temperature of less than about 40° F.

23. The method of claim 22 wherein the collected cooked meat product and liquid have a combined weight that is at least about 30 percent greater than the weight of the shredded raw meat prior to cooking.

24. The method of claim 22 wherein the collected meat product is cooled to a temperature of less than about 40° F. within less than about 1 hour.
